(19) United States
(12) Patent Application Publication
(10) Pub. No.: US 2010/0086698 A1
(43) Pub. Date: Apr. 8, 2010

(54) METHOD OF PRODUCING MULTILAYER COATING FILM

(75) Inventor: Kiyoshi ITOH, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: DAI NIPPON PRINTING CO., LTD., Shinjuku-ku (JP)

(21) Appl. No.: 12/573,389

(22) Filed: Oct. 5, 2009

(30) Foreign Application Priority Data
Oct. 6, 2008 (JP) 2008-259615

(51) Int. Cl. B05D 1/30

(52) U.S. Cl. 427/420

(57) ABSTRACT

Provided is a method of producing a multilayer coating film, including the steps of: turning multiple coating liquids into multiple layers in advance; and transferring the coating liquids turned into multiple layers onto a substrate, in which a coating liquid having the following characteristics is inserted as an intermediate layer between two kinds of coating liquids to be laminated so that the coating liquids are turned into multiple layers: the coating liquid contains both film-forming components in the two kinds of coating liquids, and a total concentration of the film-forming components is higher than a concentration of the film-forming component in each of the two kinds of coating liquids. The production method includes producing a multilayer coating film extremely excellent in interlayer adhesiveness with ease and good productivity, by collectively applying multiple coating liquids without using a gelling agent or the like for modifying the viscosity of each coating liquid to be laminated.

### BACKGROUND OF THE INVENTION

1. Field of the Invention

The present invention relates to a method of producing a multilayer coating film, and more specifically, to a method of producing a multilayer coating film extremely excellent in interlayer adhesiveness with ease and good productivity, the method including collectively applying multiple coating liquids.

2. Description of the Related Art

Conventionally, there is known a multilayer coating method with which multiple layers are formed on a running substrate by one application process, and the multilayer coating method has been widely utilized in a coating process for a photographic film or the like. As illustrated in FIG. 1, a coating method according to the method involves: extruding coating liquids A and B from multiple narrow slits in an application head 1; causing the liquids to flow down naturally by virtue of gravity on an inclined slide surface 2; and transferring the overlapping coating liquids A and B onto a running substrate 4 with a roll 3 to form a multilayer coating film.

Such a method is effective in aqueous coating liquids, and the following method has been known: multiple layers of halogenated emulsions each using gelatin as a binder are simultaneously applied, and are then cooled. The method intends to form a coating film by, for example, drying with hot air on the following condition: a multilayer film is caused to gel by utilizing the sol-gel transformation characteristic of gelatin so as to be in an ultrahigh-viscosity state, and hence, the occurrence of the mixing of layers is suppressed.

On the other hand, organic solvent-based coating liquids each have a lower surface tension than those of the aqueous coating liquids, so the organic solvent-based coating liquids are apt to diffuse and to mix with each other. In addition, no sol-gel transformation substances effective in the organic solvent-based coating liquids have been found. Therefore, in the case of the organic solvent-based coating liquids, the following method has been adopted: layers of the coating liquids are applied one by one, and are then dried. Because such a one-by-one application and drying method requires an enormous production cost and an extremely long production time, a method of forming multiple layers by one application process has been heretofore proposed for the organic solvent-based coating liquids as well.

For example, the following method has been proposed (see Japanese Examined Patent Publication No. Sho 63-20584): a viscosity-modifying component such as a thickener is added so that flowability at an interface between two contacting layers or the extent to which the layers mix with each other may be controlled. The method requires a certain amount of a thickener for viscosity modification. In addition, such an additive is generally a low-molecular-weight organic material, and is assumed to move in a layer, or across layers, during multilayer coating or after the formation of a laminate to reduce the mechanical characteristics or interlayer adhesiveness of the laminate; in some applications, the method has been inapplicable.

In addition, the following method has been proposed (see Japanese Patent Application Laid-Open No. Hei 07-136578): two kinds of organic solvent-based coating liquids are used, and a surfactant is added to one of the coating liquids to control the surface tension of the coating liquid so that a substrate may be coated with multiple layers simultaneously in a state where an interface between two layers of the coating liquids is maintained.

However, the method also involves the same problems as those described above because the method requires the addition of a certain amount of the surfactant.

Further, the following method has been proposed (see Japanese Patent Application Laid-Open No. Sho 61-74675). An electron beam-curable compound is added to at least one kind of two or more kinds of nonaqueous application liquids, and multiple layers of the application liquids are simultaneously applied. After that, the applied layers are irradiated with electron beams so as to be cured or thickened. Then, the layers are dried so that a multilayer coating film may be obtained.

However, the method involves the following problems: the step of irradiating the layers with the electron beams must be performed after the applying step before the application liquids diffuse or mix with each other, so the operations are complicated; in addition, a large apparatus is needed.

### SUMMARY OF THE INVENTION

The present invention has been made in view of such circumstances, and an object of the present invention is to provide a method of producing a multilayer coating film extremely excellent in interlayer adhesiveness with ease and good productivity, the method including collectively applying multiple coating liquids without using a gelling agent or the like for modifying the viscosity of each coating liquid to be laminated.

The inventors of the present invention have made extensive studies with a view to achieving the object. As a result, the inventors have found that, when a coating liquid having the following characteristics is inserted as a thin intermediate layer between two kinds of coating liquids to be laminated, the intermediate layer prevents the mixing of the layers of the two kinds of coating liquids, and a laminated structure of the two kinds of coating liquids (concentration gradient structure near an interface between the layers) is favorably formed, though the structure has no clear boundary surface: the coating liquid contains both film-forming components in the two kinds of coating liquids, and the total concentration of the film-forming components is higher than the concentration of the film-forming component in each of the two kinds of coating liquids. The present invention has been completed on the basis of such a finding.

That is, the present invention relates to the following items [1] to [7]:

[1] a method of producing a multilayer coating film, the method including the steps of: turning multiple coating liquids into multiple layers in advance; and transferring the coating liquids turned into multiple layers onto a substrate, in which a coating liquid having the following characteristics is inserted as an intermediate layer between two kinds of coating liquids to be laminated so that the coating liquids are turned into multiple layers: the coating liquid contains both film-forming components in the two kinds of coating liquids, and a total concentration of the film-forming components is higher than a concentration of the film-forming component in each of the two kinds of coating liquids;

[2] the method of producing a multilayer coating film according to the item [1], in which a solvent in each of the coating liquids includes an organic solvent;

[3] the method of producing a multilayer coating film according to the item [1], in which the concentration of the film-forming components in the coating liquid used as the intermediate layer is higher than the concentration of the film-forming component in each of the two kinds of coating liquids to be laminated by at least 20 mass %;

[4] the method of producing a multilayer coating film according to the item [3], in which the concentration of the film-forming component in each of the two kinds of coating liquids to be laminated is 20 to 50 mass %;

[5] the method of producing a multilayer coating film according to the item [1], in which: an inclined slide surface is used when the multiple coating liquids are turned into multiple layers in advance; and the slide surface has an inclination angle of 5 to 40° with respect to a horizontal direction;

[6] a multilayer coating film obtained by the production method according to any one of the items [1] to [5]; and

[7] a method of coating a substrate with multiple layers, the method including: turning multiple coating liquids into multiple layers in advance; and transferring the coating liquids turned into multiple layers onto the substrate to form a multilayer coating film, in which a coating liquid having the following characteristics is inserted as an intermediate layer between two kinds of coating liquids to be laminated so that the coating liquids are turned into multiple layers: the coating liquid contains both film-forming components in the two kinds of coating liquids, and a total concentration of the film-forming components is higher than a concentration of the film-forming component in each of the two kinds of coating liquids.

According to the present invention, there can be provided a method of producing a multilayer coating film extremely excellent in interlayer adhesiveness with ease and good productivity without using any gelling agent or the like for viscosity modification, the method involving inserting a coating liquid having the following characteristics as a thin intermediate layer between two kinds of coating liquids to be laminated so that the intermediate layer may prevent the mixing of the layers of the two kinds of coating liquids: the coating liquid contains both film-forming components in the two kinds of coating liquids, and the total concentration of the film-forming components is higher than the concentration of the film-forming component in each of the two kinds of coating liquids.

### BRIEF DESCRIPTION OF THE DRAWINGS

FIG. 1 is a conceptual view illustrating an example of an apparatus for performing a method of simultaneously coating a substrate with multiple layers.

FIG. 2 is a photograph of a two-layer coating film obtained in Example 1 taken with a scanning electron microscope.

### DETAILED DESCRIPTION OF THE PREFERRED EMBODIMENTS

Hereinafter, a method of producing a multilayer coating film of the present invention is described in detail. Although the following description is given by taking a method of producing a simultaneous multilayer coating film formed of two layers as an example, the present invention is not limited to the production of a multilayer coating film formed of two layers, and is applicable to the production of a simultaneous multilayer coating film formed of three or more layers as well.

The method of producing a multilayer coating film of the present invention involves: turning multiple coating liquids, i.e., an upper layer coating liquid A and a lower layer coating liquid B into multiple layers in advance; and transferring the coating liquids turned into multiple layers onto a substrate to produce the multilayer coating film.

Although a method of turning the multiple coating liquids, i.e., the upper layer coating liquid A and the lower layer coating liquid B into multiple layers in advance is not particularly limited, examples of the method include (1) a method involving turning the coating liquids into multiple layers on an inclined slide surface, (2) a method involving turning the coating liquids into multiple layers on a horizontal plane, (3) a method involving turning the coating liquids into multiple layers on a circular cylinder, and (4) a method involving turning the coating liquids into multiple layers on an inclined paraboloid. Of those, the method (1) is preferably used in ordinary cases.

The present invention has enabled the formation of a coating film, which has no clearly formed boundary surface but is entirely formed of multiple layers simultaneously laminated, without the use of a gelling agent or the like which may have a detrimental effect such as a reduction in film strength through the insertion of a “mixed coating liquid A/B” having the following characteristics as a thin intermediate layer between two kinds of coating liquids A and B to be laminated: the mixed coating liquid contains both film-forming components in the two kinds of coating liquids, and the total concentration of the film-forming components is higher than the concentration of the film-forming component in each of the two kinds of coating liquids.

In this case, a solvent in each of the multiple coating liquids is preferably an organic solvent in terms of the effect of the present invention.

In the present invention, the concentration of the film-forming components in “the mixed coating liquid A/B” used as the intermediate layer is preferably higher than the concentration of the film-forming component in each of the two kinds of coating liquids A and B to be laminated by at least 20 mass % from the viewpoint of the prevention of the mixing of the two kinds of coating liquids to be laminated. The higher the concentration in the mixed coating liquid A/B, the better; the concentration is higher than the concentration in each of the two kinds of coating liquids A and B to be laminated by more preferably 20 to 100 mass %, or still more preferably 30 to 80 mass % from the viewpoints of, for example, the viscosity of the mixed coating liquid A/B and the solubility of each film-forming component in a solvent.

In addition, the concentration of the film-forming component in each of the two kinds of coating liquids A and B to be laminated is typically about 20 to 50 mass %, or preferably 25 to 45 mass % from the viewpoint of a balance between, for example, the ease with which the multilayer coating film is formed and the productivity of the film.

A solvent used in each of the coating liquids A and B, and the mixed coating liquid A/B is not particularly limited, and a solvent to be used is appropriately selected from various solvents such as toluene, xylene, acetone, methyl ethyl ketone, methyl isobutyl ketone, cyclohexanone, ethyl acetate, butyl acetate, tetrahydrofuran, ethyl cellosolve, propylene glycol monomethyl ether, methanol, ethanol, isopropanol, isobutanol, and hexane in accordance with the kinds of the film-forming components used in the respective coating liquids. One kind of those solvents may be used alone, or two or more kinds of them may be used as a mixture.

In addition, the solvent of the mixed coating liquid A/B used as the intermediate layer may be the same as that of the coating liquid A or B, or may be different from that of the coating liquid A or B. Alternatively, when the solvents of the coating liquids A and B are different from each other, a mixture of both the solvents may be used in the mixed coating liquid A/B.

It should be noted that the film-forming components are described later.

Various additives such as an antioxidant, a UV absorber, a light stabilizer, a leveling agent, and a defoaming agent can be added to each of the coating liquids in addition to the film-forming components as required.

A gelling agent or thickener typically used for improving the viscosity of a coating liquid must be added in a large amount in many cases in order that its effect is obtained, though the amount varies depending on the composition of the coating liquid to which the gelling agent or thickener is added. As a result, for example, the following fear arises: the gelling agent or thickener moves in a layer, or across layers, after lamination so as to precipitate on an interface between layers or the surface of a layer so that the mechanical strength or interlayer adhesiveness of the multilayer coating film may decrease. In addition, the number of materials that have been proposed at present serving as gelling agents or thickeners effective for organic solvent-based inks targeted by the present invention is not very large, though various kinds of materials serving as gelling agents or thickeners for aqueous inks and alcohol-based inks have been proposed.

The present invention does not utilize viscosity modification with a gelling agent or the like, but has provided a significant preventing effect on the mixing of two kinds of coating liquids which intrinsically mix with each other through the following procedure: a coating liquid into which the film-forming components of the two kinds of coating liquids have been mixed at a high concentration in advance is prepared, and is inserted as an intermediate layer between the two kinds of coating liquids.

In the present invention, the intermediate layer is preferably inserted to have as small a thickness as possible. When the intermediate layer is inserted to have a large thickness, a concentration gradient hardly arises, so the two kinds of coating liquids may mix with each other as in the case where the coating liquids are simply laminated without being treated. The intermediate layer is inserted to have a wet thickness of preferably 1 μm to 100 μm, more preferably 5 μm to 80 μm, or still more preferably 10 μm to 50 μm.

Although the intermediate layer inserted to have a small thickness is initially in such a state that the film-forming components are completely mixed, the intermediate layer moves toward a portion having a lower concentration after having contacted the two kinds of coating liquids because the intermediate layer has a high concentration. The intermediate layer starts to divide with the intention of moving toward each of, in particular, homogeneous materials each having a high affinity for the other, that is, the two kinds of coating liquids above and below the intermediate layer, thereby suppressing the mixing of the two kinds of coating liquids above and below the intermediate layer. The movement and the division stop at a stage where a concentration gradient is alleviated to some extent. As a result, a concentration gradient structure is formed near a boundary surface between the coating liquids.

### (Film-Forming Component of Coating Liquid)

A film-forming component used in each of the coating liquids in the present invention is not particularity limited as long as a desired film can be formed of the component, and the component is appropriately selected in accordance with the applications of a multilayer coating film to be obtained. For example, a thermoplastic resin such as a polyester-based resin, a polyester urethane-based resin, an acrylic resin, a denatured acrylic resin, or a polycarbonate can be used. One kind of them may be used alone, or two or more kinds of them may be used in combination. Those thermoplastic resins have a weight-average molecular weight of preferably several tens of thousand to several millions, or more preferably 30,000 to 500,000.

In addition, in the present invention, an active energy ray-curable compound can also be used as the film-forming component of each coating liquid.

The active energy ray-curable compound is a compound having an energy quantum in an electromagnetic wave or charged particle beam, that is, a compound the molecules of which crosslink and cure by being irradiated with ultraviolet rays, electron beams, or the like. At least one of such active energy ray-curable oligomers and active energy ray-curable monomers as described below can be used as the active energy ray-curable compound.

Examples of the active energy ray-curable oligomers include polyester acrylate-, epoxy acrylate-, urethane acrylate-, polyether acrylate-, polybutadiene acrylate-, and silicone acrylate-based oligomers.

Here, the polyester acrylate-based oligomer can be obtained by, for example, esterifying a hydroxyl group of a polyester oligomer having hydroxyl groups at both of its terminals obtained by the condensation of a polyhydric alcohol with (meth)acrylic acid or esterifying the hydroxyl group at a terminal of an oligomer obtained by adding an alkylene oxide to a polyvalent carboxylic acid with (meth)acrylic acid. The epoxy acrylate-based oligomer can be obtained by, for example, causing (meth)acrylic acid to react with the oxirane ring of a bisphenol-type epoxy resin or novolac-type epoxy resin having a relatively low molecular weight (for example, less than 5,000) to esterify the ring. In addition, a carboxyl-denatured epoxy acrylate oligomer obtained by partially denaturing the epoxy acrylate-based oligomer with a dibasic carboxylic anhydride can also be used. The urethane acrylate-based oligomer can be obtained by, for example, esterifying a polyurethane oligomer obtained by a reaction between a polyether polyol or polyester polyol and a polyisocyanate with (meth)acrylic acid. The polyol acrylate-based oligomer can be obtained by esterifying a hydroxyl group of a polyether polyol with (meth)acrylic acid.

The weight-average molecular weight of each of the above oligomers is selected from the range of preferably 500 to 100,000, more preferably 1,000 to 70,000, or still more preferably 3,000 to 40,000 in terms of a standard polystyrene measured by a gel permeation chromatography (GPC) method.

One kind of the oligomers may be used alone, or two or more kinds of them may be used in combination.

On the other hand, examples of the active energy ray-curable monomers include 1,4-butanediol di(meth)acrylate, 1,6-hexanediol di(meth)acrylate, neopentyl glycol di(meth)acrylate, polyethylene glycol di(meth)acrylate, neopentyl glycol adipate di(meth)acrylate, hydroxypivalate neopentyl glycol di(meth)acrylate, dicyclopentanyl di(meth)acrylate, caprolactone-modified dicyclopentenyl di(meth)acrylate, ethyleneoxide-modified phosphate di(meth)acrylate, allylated cylclohexyl di(meth)acrylate, isocyanurate di(meth)acrylate, dimethyloltricyclodecane di(meth)acrylate, trimethylolpropane tri(meth)acrylate, dipentaerythritol tri(meth)acrylate, propionate-modified dipentaerythritol tri(meth)acrylate, pentaerythritol tri(meth)acrylate, propionoxide-modified trimethylolpropane tri(meth)acrylate, tris(acryloxyethyl) isocyanurate, propionate-modified dipentaerythritol penta(meth)acrylate, dipentaerythritol hexa(meth)acrylate, and caprolactone-modified dipentaerythritol hexa(meth)acrylate. One kind of those monomers may be used alone, or two or more kinds of them may be used in combination.

Further, in addition to the active energy ray-curable compounds, a photopolymerization initiator may also be used. Examples of the photopolymerization initiator include benzoine, benzoine methyl ether, benzoine ethyl ether, benzoine isopropyl ether, benzoine-n-butyl ether, benzoine isobutyl ether, acetophenone, dimethylaminoacetophenone, 2,2-dimethoxy-2-phenylacetophenone, 2,2-dimethoxy-1,2-diphenylethane-1-one, 2,2-diethoxy-2-phenylacetophenone, 2-hydroxy-2-methyl-1-phenylpropane-1-one, 1-hydroxycyclohexyl phenyl ketone, 2-methyl-1-[4-(methylthio)phenyl]-2-morphorinopropane-1-one, 4-(2-hydroxyethoxy)phenyl-2(hydroxy-2-propyl) ketone, benzophenone, p-phenylbenzophenone, 4,4′-diethylaminobenzophenone, dichlorobenzophenone, 2-methylanthraquinone, 2-ethylanthraquinone, 2-tert-butylanthraquinone, 2-aminoanthraquinone, 2-methylthioxanthone, 2-ethylthioxanthone, 2-chlorothioxanthone, 2,4-dimethylthioxanthone, 2,4-diethylthioxanthone, benzyl dimethyl ketal, acetophenone dimethyl ketal, p-dimethylamine benzoate, and oligo(2-hydroxy-2-methyl-1-[4-(1-propenyl)phenyl]propanone). One kind of them may be used alone, or two or more kinds of them may be used in combination. The amount in which the photopolymerization initiator is used has only to be appropriately selected in accordance with the kind of the active energy ray-curable compound to be used; the photopolymerization initiator is typically used in an amount ranging from 0.001 to 0.5 times the mass of the active energy ray-curable compound.

### (Substrate)

A substrate to which the coating liquids are applied is not particularly limited, and can be appropriately selected in accordance with the applications of a member having the multilayer coating film. Particularly when the multilayer coating film according to the present invention is used in an optical member, a film appropriately selected from known plastic films can be used as the substrate of the optical film. Examples of such plastic films include polyester films such as polyethylene terephthalate, polybutylene terephthalate, and polyethylene naphthalate; polyethylene films; polypropylene films; cellophane; diacetylcellulose films; triacetylcellulose films; acetylcellulose butylate films; polyvinyl chloride films; polyvinylidene chloride films; polyvinyl alcohol films; etyhlene/vinyl acetate copolymer films; polystyrene films; polycarbonate films; polymethylpentene films; polysulfone films; polyetheretherketone films; polyethersulfone films; polyetherimide films; polyimide films; fluororesin films; polyamide films; acrylic resin films; norbornene-based resin films; and cycloolefin resin films.

Those substrates may be transparent, or may be semitransparent, and may be colored, or may be colorless; an appropriate substrate has only to be selected in accordance with the applications of the multilayer coating film. For example, when the multilayer coating film is used for protecting a liquid crystal display, a colorless, transparent film is preferable.

The thickness of any such substrate is not particularly limited, and is appropriately selected in accordance with circumstances; the thickness falls within the range of typically 15 to 250 μm, or preferably 30 to 200 μm. In addition, one surface or both surfaces of the substrate can be subjected to a surface treatment by, for example, an oxidation method or irregularity method as desired with a view to improving adhesiveness between a surface and a layer provided on the surface. Examples of the above oxidation method include a corona discharge treatment, a chromic acid treatment (wet), a flame treatment, a hot air treatment, and an ozone/UV irradiation treatment. In addition, examples of the irregularity method include a sandblast method and a solvent treatment method. A method for the surface treatment is appropriately selected from those methods in accordance with the kind of the substrate; in general, the corona discharge treatment method is preferably employed in terms of, for example, its effect and operability.

### (Formation of Multilayer Coating Film)

As described above, a method involving turning multiple coating liquids into multiple layers in advance and transferring the coating liquids turned into multiple layers onto a substrate is adopted in the present invention.

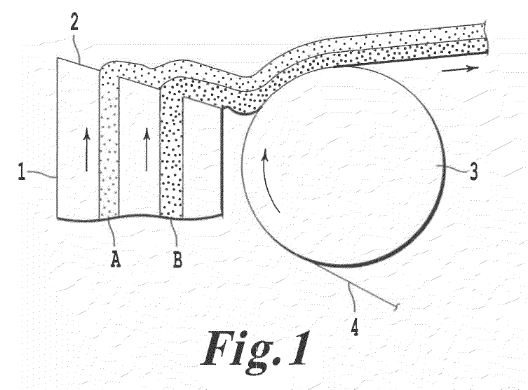

In the case where an inclined slide surface is utilized when the coating liquids are turned into multiple layers, such a slide coater as illustrated in FIG. 1 is a preferable example of a product having the inclined slide surface for causing the coating liquids to flow. It should be noted that a slit for the mixed coating liquid A/B is provided between slits for the coating liquids A and B on the slide surface 2 in the present invention.

The slide surface has an inclination angle of preferably 5 to 40°, more preferably 10 to 35°, or still more preferably 15 to 35° with respect to a horizontal direction. In addition, a distance between the center of an orifice for ejecting a coating liquid onto the slide surface and the center of an adjacent orifice for ejecting a coating liquid is preferably 8 to 30 cm, more preferably 10 to 28 cm, or still more preferably 12 to 26 cm. Further, a distance between the center of the ejection orifice closest to a site where the coating liquids are transferred onto the substrate out of the multiple orifices for ejecting the coating liquids onto the slide surface and the substrate is preferably 2 to 14 cm, more preferably 3 to 12 cm, or still more preferably 4 to 11 cm. Particularly when a slide coater designed as described above is used, the effect of the present invention tends to appear saliently.

Hereinafter, an example of a method of turning the coating liquids into multiple layers is described in detail with reference to the slide coater of FIG. 1.

The coating liquid A, the mixed coating liquid A/B, and the coating liquid B are extruded from three slit-like ejection orifices in the application head 1, and are then caused to flow down naturally by virtue of gravity on the inclined slide surface 2 so that the coating liquids A and B may be turned into multiple layers through the mixed coating liquid A/B. The coating liquids turned into multiple layers (coating films) are transferred onto the running substrate 4 with the roll 3.

When the film-forming component in each coating liquid is such a thermoplastic resin as described above, the multilayer coating film can be formed by: coating on top of the substrate with multiple layers of the coating liquids as described above; and heating and drying the coating liquids as appropriate. The temperature at which the coating liquids are heated and dried is typically 40 to 150° C., preferably 50 to 120° C., or more preferably 60 to 90° C. The time period for which the coating liquids are heated and dried, which is not particularly limited, is typically about 1 to 5 minutes.

On the other hand, when the film-forming component in each coating liquid is such an active energy ray-curable compound as described above, the multilayer coating film is formed by: heating and drying the coating liquids as described above; and irradiating the dried products with active energy rays to cure the dried products. Examples of the active energy rays include ultraviolet rays and electron beams. The above ultraviolet rays can be obtained by using, for example, a high-pressure mercury lamp, a fusion H lamp, or a xenon lamp while the electron beams can be obtained by using, for example, an electron beam accelerator. Of the active energy rays, the ultraviolet rays are particularly suitable. It should be noted that, when the electron beams are used, a cured film can be obtained without adding any photopolymerization initiator.

When the active energy rays are the ultraviolet rays, the quantity of the ultraviolet rays is preferably about 50 to 200 mJ/cm².

The multilayer coating film thus formed has a thickness of typically about 0.1 μm to 10 μm, or preferably 1 μm to 5 μm, and is such that the layers formed of the respective coating liquids are separated from each other.

The separated-layer structure can be observed with, for example, an interfacial ultraviolet and visible spectrophotometer utilizing slab optical waveguide spectrometry. In addition, the structure can be observed by investigating its section with a scanning electron microscope (SEM) or optical microscope as well.

Because an additive such as a gelling agent is not used in the present invention, a detrimental effect caused by the additive can be eliminated, and the elimination is effective in reducing a cost for the production of the multilayer coating film.

### EXAMPLES

Next, the present invention is described in more detail by way of examples. However, the present invention is by no means limited by those examples.

### Production Example 1

42 g of a polymethyl methacrylate (manufactured by KANTO CHEMICAL CO., INC.), 58 g of methyl isobutyl ketone (manufactured by KANTO CHEMICAL CO., INC.) as a solvent, and 0.5 g of a colorant for identification “Solvent Red 24” (manufactured by KANTO CHEMICAL CO., INC.) were mixed and stirred at room temperature. Thus, a coating liquid 1 (concentration of the polymethyl methacrylate: 41.8 mass %) was obtained.

### Production Example 2

38 g of a polycarbonate (manufactured by Acros Organics), 52 g of toluene (manufactured by KANTO CHEMICAL CO., INC.) as a solvent, and 0.5 g of a colorant for identification “Solvent Blue 63” (manufactured by KANTO CHEMICAL CO., INC.) were mixed and stirred at room temperature. Thus, a coating liquid 2 (concentration of the polycarbonate: 42.0 mass %) was obtained.

### Production Example 3

50 g of a polymethyl methacrylate (manufactured by KANTO CHEMICAL CO., INC.), 50 g of a polycarbonate (manufactured by Acros Organics), and 80 g of methyl isobutyl ketone as a solvent were mixed and stirred at room temperature. Thus, a coating liquid 3 (total concentration of the polymethyl methacrylate and the polycarbonate: 55.6 mass %) was obtained.

### Example 1

The coating liquid 1 produced in Production Example 1 was used as a lower layer coating liquid, the coating liquid 2 produced in Production Example 2 was used as an upper layer coating liquid, and the coating liquid 3 produced in Production Example 3 was used as an intermediate layer. The top of a polyethylene terephthalate film “COSMOSHINE A4100” having a thickness of 100 μm (manufactured by Toyobo Co., Ltd.) was coated with the coating liquids by using the apparatus as illustrated in FIG. 1 (provided that the apparatus used here further had a slit for the mixed coating liquid A/B on the slide surface 2; an inclination angle of 25° with respect to a horizontal direction; a distance between the center of an orifice for ejecting a coating liquid onto the slide surface and the center of an adjacent orifice for ejecting a coating liquid is 8 cm; and a distance between the center of the ejection orifice closest to a site where the coating liquids are transferred onto the substrate out of the multiple orifices for ejecting the coating liquids onto the slide surface and the substrate is preferably 10 cm). After the coating, the coating films were cured by being dried in an oven at 70° C. for 2 minutes.

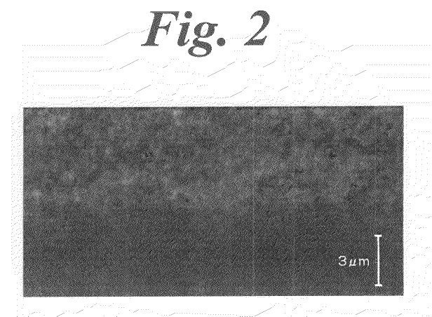

The section of the coating films was observed with a scanning electron microscope (SEM). As a result, no significant mixing of the colorants for identification was observed in the two coating films, i.e., the upper and lower layers to which the colorants for identification had been added, so the formation of a good multilayer coating film was observed. FIG. 2 illustrates an SEM photograph of the section of the coating films.

### Comparative Example 1

Coating films were formed on the polyethylene terephthalate film in the same manner as in Example 1 except that the intermediate layer was not inserted. The section of the coating films was observed with an SEM. As a result, the colorants for identification mixed with each other, so an interface between the coating films could not be secured. Accordingly, the formation of a laminated structure could not be observed.

### INDUSTRIAL APPLICABILITY

According to the method of the present invention, a multilayer coating film having extremely high interlayer adhesiveness can be provided with ease and high productivity by using organic solvent-based coating liquids without using any gelling agent or the like for viscosity modification. Therefore, the employment of the method enables the production of a multilayer film such as an optical film with high productivity without involving reductions in various physical properties of the film.

The disclosure of the priority document, JP 2008-259615, filed in Japan on Oct. 6, 2008, is incorporated by reference herein in its entirety.

### REFERENCE SIGNS LIST

1: application head
2: slide surface
3: roll
4: substrate
A: upper layer coating liquid
B: lower layer coating liquid

What is claimed is:

1. A method of producing a multilayer coating film, the method comprising
inserting a first coating liquid between a second coating liquid and a third coating liquid to form a multilayered coating; and
transferring the multilayered coating onto a substrate, wherein
the second coating liquid contains second film-forming components;
the third coating liquid contains third film-forming components;
the first coating liquid contains both the second film-forming components and the third film-forming components; and
a total concentration in the first coating liquid of the second film-forming components and the third film-forming components is higher than a concentration of the second film-forming components in the second coating liquid and is higher than a concentration of the third film-forming components in the third coating liquid.

2. The method according to claim 1, wherein each of the first coating liquid, the second coating liquid and the third coating liquid comprises an organic solvent.

3. The method according to claim 1, wherein
the total concentration in the first coating liquid of the second film-forming components and the third film-forming components is higher than the concentration of the second film-forming components in the second coating liquid by at least 20 mass %; and
the total concentration in the first coating liquid of the second film-forming components and the third film-forming components is higher than the concentration of the third film-forming components in the third coating liquid by at least 20 mass %.

4. The method according to claim 3, wherein
the concentration of the second film-forming components in the second coating liquid is in a range of from 20 to 50 mass %; and
the concentration of the third film-forming components in the third coating liquid is in a range of from 20 to 50 mass %.

5. The method according to claim 1, wherein the first coating liquid does not contain a gelling agent.

6. The method according to claim 1, wherein the second coating liquid and the third coating liquid do not contain a gelling agent.

7. The method according to claim 1, wherein
the multilayered coating is formed on a slide surface; and
the slide surface has an inclination angle in a range of from 5° to 40° with respect to a horizontal direction.

8. The method according to claim 2, wherein the organic solvent comprises at least one selected from the group consisting of toluene, xylene, acetone, methyl ethyl ketone, methyl isobutyl ketone, cyclohexanone, ethyl acetate, butyl acetate, tetrahydrofuran, ethyl cellosolve, propylene glycol monomethyl ether, methanol, ethanol, isopropanol, isobutanol, and hexane.

9. The method according to claim 1, wherein
the first coating liquid comprises a first organic solvent;
the second coating liquid comprises a second organic solvent;
the third coating liquid comprises a third organic solvent; and
the first organic solvent, the second organic solvent and the third organic solvent have different compositions.

10. The method according to claim 1, wherein the second film-forming components and the third film-forming components are independently selected from the group consisting of thermoplastic resins having a weight-average molecular weight in a range of from 30,000 to 500,000.

11. The method according to claim 10, wherein the thermoplastic resins are selected from the group consisting of polyester-based resins, a polyester urethane-based resins, acrylic resins, denatured acrylic resins, and polycarbonates.

12. The method according to claim 1, wherein at least one of the second film-forming components and the third film-forming components comprises at least one active energy ray-curable compound.

13. The method according to claim 12, wherein the at least one active energy ray-curable compound comprises an oligomer having a weight-average molecular weight in a range of from 500 to 100,000 that is selected from the group consisting of polyester acrylate-based oligomers, epoxy acrylate-based oligomers, urethane acrylate-based oligomers, polyether acrylate-based oligomers, polybutadiene acrylate-based oligomers, and silicone acrylate-based oligomers.

14. The method according to claim 12, wherein the at least one active energy ray-curable compound comprises an active energy ray-curable monomer.

15. The method according to claim 1, wherein the substrate comprises a plastic.

16. The method according to claim 1, further comprising heating the multilayered coating on the substrate to a temperature in a range of from 40° C. to 150° C.

17. The method according to claim 1, further comprising irradiating the multilayered coating on the substrate with active energy rays.

18. A method of coating a substrate with multiple layers, the method comprising:
inserting a first coating liquid between a second coating liquid and a third coating liquid to form a multilayered coating; and
transferring the multilayered coating onto the substrate to form a multilayer coating film, wherein
the second coating liquid contains second film-forming components;
the third coating liquid contains third film-forming components;
the first coating liquid contains both the second film-forming components and the third film-forming components; and
a total concentration in the first coating liquid of the second film-forming components and the third film-forming components is higher than a concentration of the second film-forming components in the second coating liquid and is higher than a concentration of the third film-forming components in the third coating liquid.

19. A multilayer coating film produced by the method of claim 1.
